(19) United States
(12) Patent Application Publication
(10) Pub. No.: US 2008/0230092 A1
(43) Pub. Date: Sep. 25, 2008

(54) METHOD AND APPARATUS FOR SINGLE-SUBSTRATE CLEANING

(76) Inventors: Alexander Sou-Kang Ko, Santa Clara, CA (US); Jianshe Tang, San Jose, CA (US); Brian J. Brown, Palo Alto, CA (US); Richard R. Endo, San Carlos, CA (US); Steven Verhaverbeke, San Francisco, CA (US); Cole Franklin, Sunnyvale, CA (US); Dennis J. Yost, Los Gatos, CA (US); Runzi Chang, Santa Clara, CA (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/690,405

(22) Filed: Mar. 23, 2007

(51) Int. Cl. B08B 3/00

(52) U.S. Cl. 134/36; 700/266

(57) ABSTRACT

A single-substrate cleaning apparatus and method of use are described. In an embodiment of the present invention, a liquid cleaning solution is dispensed in small volumes to form a substantially uniform static liquid layer over a substrate surface by atomizing the viscous liquid with an inert gas in a two-phase nozzle. In another embodiment of the present invention, after a layer of the cleaning solution is formed over the substrate to be cleaned, acoustic energy is applied to the substrate to improve the cleaning efficiency. In a further embodiment, cleaning solution precipitates are avoided by dispensing de-ionized water with a spray nozzle to gradually dilute the cleaning solution prior to dispensing de-ionized water with a stream nozzle.

### BACKGROUND OF THE INVENTION

1. Field of the Invention

The present invention relates to the field of manufacturing equipment for processing individual substrate with wet chemistry and more particularly to single-substrate wet chemical cleaning methods for the electronics industries.

2. Discussion of Related Art

Removal of residue from substrate surfaces is becoming increasingly difficult as the device features in semiconductor integrated circuit manufacturing scale down to sub-100 nm dimensions and novel materials, such as Cu interconnects and low-k films, are employed. These higher aspect ratios and novel materials are sufficiently fragile to render traditional wet chemical cleaning methods and apparatuses incapable. For example, batch wet cleaning in a solvent bath can cause undesirable undercutting of Cu interconnects. Such undercutting has been linked to metallic contamination in the cleaning solvent having higher reduction potential than Cu. By oxidizing the interconnect metal, the metallic contamination forms soluble cupric ions. Because the cleaning solution is recirculated through the bath for either a fixed period of time or number of batches, batch wet cleaning processes are susceptible to accumulation of metal ions and polymer residue which cannot be entirely filtered out of the solvent media. Therefore, substrates processed near the end of the bath life are exposed to more contaminants during the substrate clean than those processed in a fresh bath. Interconnect undercut can therefore occur to varying degrees and once formed, the undercut may create voids resulting in electromigration failures.

In addition to the presence of metallic contamination, also of concern is the duration of the solvent clean. The longer the clean, the more severe the Cu undercutting will be at a given metallic contamination level, so it is advantageous to increase the cleaning efficiency of a cleaning solution to minimize the time the substrate surfaces are in contact with the solution.

Furthermore, many of substrate cleaning solution chemical formulations developed in recent years have relatively high viscosities. High viscosity cleaning solutions typically pose problems for substrate cleaning apparatuses. For example, in batch substrate processes, where a large quantity of cleaning solution is continuously recirculated through a filter, the recirculation pump lifetime is inversely proportional to the viscosity of the cleaning solution. Similarly, for single-substrate processes, where cleaning solution is typically dispensed directly on an individual substrate, the higher the cleaning solution viscosity, the more difficult it is to uniformly dispense a small volume across the substrate. Single-substrate cleaning apparatuses have also typically required a large dispensed volume of hundreds of milliliters per substrate. Such high chemical use is costly and environmentally unsound, particularly if the cleaning solution is not recirculated and reused.

Yet another limitation of many cleaning solutions is sensitivity to quick dilutions. Because many modern cleaning solutions have a tendency to form precipitates when they are diluted too quickly, intermediary cleaning solutions are routinely employed prior performing a de-ionized water rinse and dry of the substrate. This sensitivity leads to product contamination, increased chemical usage, and increased process complexity.

Thus, there remains a need in semiconductor microelectronic device manufacturing for a method of cleaning fragile microelectronic device structures which is capable of efficiently using small volumes of high viscosity cleaning fluids, is of a relatively short and controlled duration, and avoids the formation of precipitates.

### SUMMARY OF THE INVENTION

The present invention is a single-substrate cleaning apparatus and method of use. In an embodiment of the present invention, the cleaning solution is atomized with an inert gas using a two-phase nozzle to dispense a substantially uniform static liquid layer having a substantially equal residence time over the entire substrate surface to be cleaned. A static liquid layer is essentially a puddle of cleaning solution which, once formed, is held on the substrate surface for a predetermined period of time after dispense of the cleaning solution is discontinued. Thus, during most of the duration of the substrate clean, there is predominantly no bulk flux of cleaning solution to or from the substrate.

In another embodiment of the present invention, after the puddle of cleaning solution is formed over the substrate to be cleaned, acoustic energy is applied to improve the cleaning efficiency.

In a further embodiment, precipitates from the cleaning solution are avoided by dispensing de-ionized water with a spray nozzle to gradually dilute the cleaning solution before dispensing de-ionized water with a stream nozzle to finally rinse the substrate. For the present invention, all of these elements work in combination to improve substrate cleaning efficiency and effectiveness.

### BRIEF DESCRIPTION OF THE DRAWINGS

FIG. 1 is an illustration of a cross-sectional view of a single-substrate cleaning apparatus in accordance with the present invention.

FIG. 2 is an illustration of a cross-sectional view of a two-phase nozzle in accordance with the present invention.

FIG. 3 is an illustration of a plan view of a cleaning fluid spray dispense pattern upon a substrate in accordance with the present invention.

FIG. 4 is a flow diagram of a method of cleaning a substrate in accordance with the present invention.

### DETAILED DESCRIPTION OF THE PRESENT INVENTION

In various embodiments, novel substrate cleaning methods are described with reference to figures wherein the same reference numbers are used to describe similar elements. However, various embodiments may be practiced without one or more of these specific details, or in combination with other known methods and materials. In the following description, numerous specific details are set forth, such as specific materials, dimensions and processes, etc. in order to provide a thorough understanding of the present invention. In other instances, well-known semiconductor processes and manufacturing techniques have not been described in particular detail in order to not unnecessarily obscure the present invention. Reference throughout this specification to “an embodiment” means that a particular feature, structure, material, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, materials, or characteristics may be combined in any suitable manner in one or more embodiments.

The present invention is a single substrate-cleaning apparatus and method of using a cleaning solution in the apparatus. The general purpose of the substrate cleaning method is to chemically dissolve and remove from the substrate various residues that are introduced to the substrate during microelectronic manufacture. The substrates applicable to the present invention include, for example, photo masking plates, compact discs, displays, and semiconductor wafers comprised of materials such as silicon, compound semiconductors, quartz, or sapphire. Examples of residues include post-etch polymers, bulk photo resist materials, and bottom anti-reflective coatings (BARC). The substrate cleaning solution for use in the present invention can be any well-known solvent or aqueous solution, and is particularly advantageous for cleaning solutions having a viscosity substantially greater than the viscosity of water. Many higher-viscosity solvents have become popular for removing residues from copper (Cu) interconnects and interlayer dielectrics having a low dielectric constant (Low-k). Generally, such cleaning solutions typically include a fluoride component, a pH buffer and a solvent matrix. Typically, the solvent matrix is amine-based or glycol based. Such solvents typically fall within a viscosity range between 20 cSt and 60 cSt at room temperature, depending on the operating temperature. A specific example of a high-viscosity cleaning solution is ST-250, available from ATMI, Inc. of Danbury, Conn. ST-250 is a proprietary solvent having a viscosity of approximately 35 centistokes (cSt) at room temperature and slightly above 10 cSt at 50 C. Even though the present invention is well suited for these higher viscosity cleaning solutions, it should be understood that lower viscosity cleaning solutions, such as ST-255 (also available from ATMI, Inc.), can also be utilized.

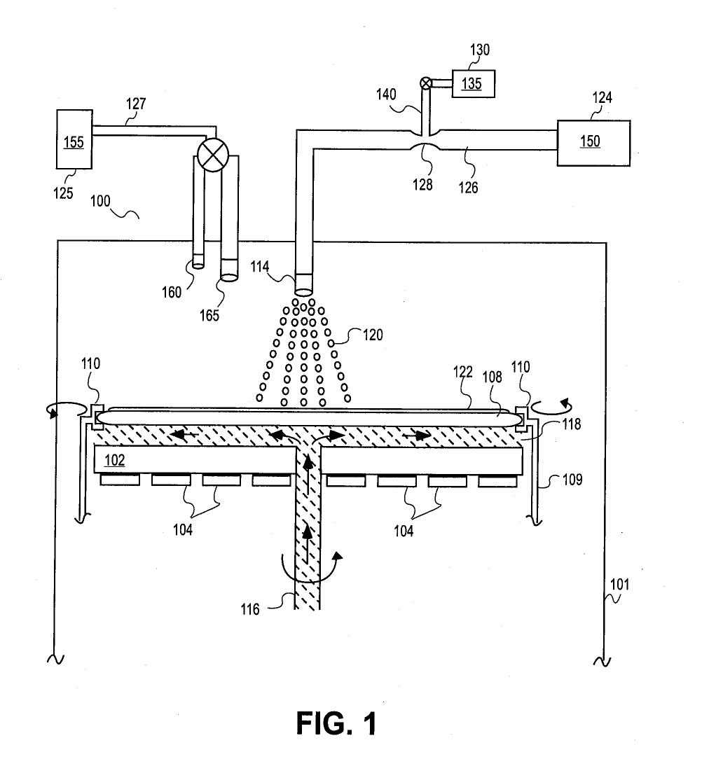

The substrate cleaning method of the present invention is ideal for use in a single substrate cleaning apparatus that utilizes acoustic energy to enhance the chemical cleaning capabilities of the cleaning solution with mechanical agitation, such as apparatus 100 shown in FIG. 1. Single-substrate cleaning apparatus 100 may be computer controlled via instructions stored on a machine readable media. The various components and actions described in reference to apparatus 100 may therefore be programmed and automated. Single-substrate cleaning apparatus 100 includes a plate 102 with a plurality of acoustic or sonic transducers 104 located thereon. The transducers 104 preferably generate megasonic waves in the frequency range above 350 kHz. The specific frequency is dependent on the thickness of the substrate and is chosen by its ability to effectively provide megasonics to both sides of the substrate. But there may be circumstances where other frequencies that do not do this may be ideal for particle removal. In an embodiment of the present invention the transducers are piezoelectric devices. The transducers 104 create acoustic waves in a direction perpendicular to the surface of substrate 108.

A substrate, or substrate, 108 is horizontally held by a substrate support 109 parallel to and spaced-apart from the top surface of plate 102. In an embodiment of the present invention, substrate 108 is held about 3 mm above the surface of plate 102 during cleaning. In an embodiment of the present invention, the substrate 108 is clamped face up to substrate support 109 by a plurality of clamps 110. Alternatively, the substrate can be supported on elastomeric pads on posts and held in place by gravity. The substrate support 109 can horizontally rotate or spin substrate 108 about its central axis at a rate of between 0-6000 rpms. Additionally, in apparatus 100 substrate 108 is placed face up wherein the side of the substrate with patterns or device features such as transistors faces towards a nozzle tip 114 for spraying cleaning chemicals thereon and the backside of the substrate faces plate 102. The transducer cover plate 102 has a substantially same shape as substrate 108 and covers the entire surface area of substrate 108. Apparatus 100 can include a sealable chamber 101 in which nozzle tip 114, substrate 108, and plate 102 are located as shown in FIG. 1.

In an embodiment of the present invention de-ionized water is fed through a feed through channel 116 of plate 102 and fills the gap between the backside of substrate 108 and plate 102 to provide a water filled gap 118 through which acoustic waves generated by transducers 104 can travel to substrate 108. In an embodiment of the present invention the feed channel 116 is slightly offset from the center of the substrate by approximately 1 mm. The backside of the substrate may alternately be rinsed with other solutions during this step. In an embodiment of the present invention de-ionized water fed between substrate 108 and plate 102 is degassed so that cavitation is reduced in the de-ionized water filled gap 118 where the acoustic waves are strongest thereby reducing potential damage to substrate 108. De-ionized water can be degassed with well known techniques at either the point of use or back at the source, such as at facilities. In an alternative embodiment of the present invention, instead of flowing de-ionized water through channel 116 during use, a cleaning solution can be fed through channel 116 to fill gap 118 to provide chemical cleaning of the backside of substrate 108, if desired.

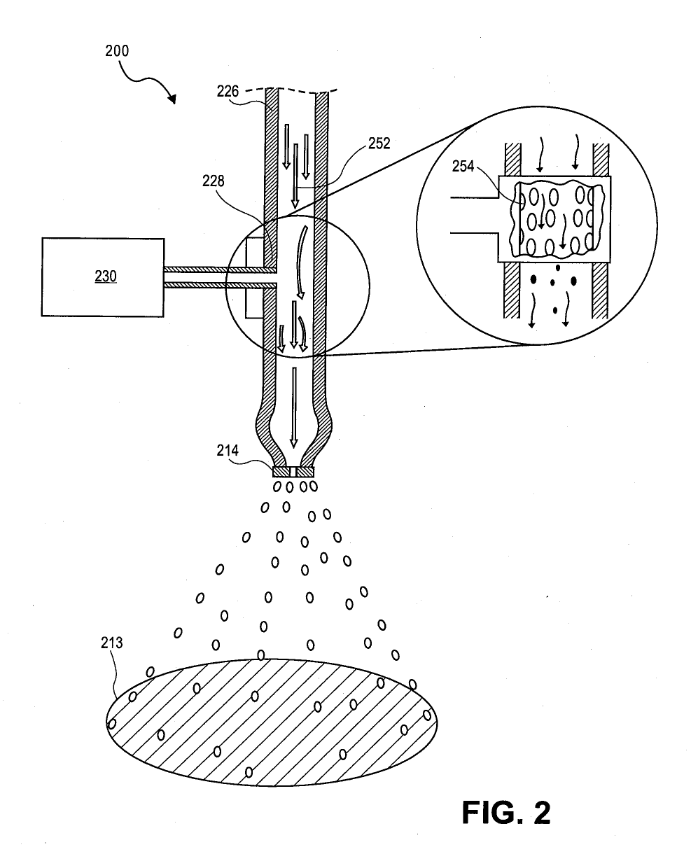

During use, cleaning solution 150 is fed from remote source 124 through conduit 126 which includes a mixer 128. An inert gas 135, such as N2, travels through conduit 140 from remote source 130 and is introduced into the liquid cleaning solution 150 as it passes through mixer 128 moving toward nozzle tip 114. The gas 135 may be any gas that will not react with the chemicals present in the cleaning solution for a particular application. Nozzle tip 114 and the mixer 128 comprise the “two-phase” spray nozzle, shown in greater detail as 200 in FIG. 2. The two-phase spray nozzle atomizes the cleaning solution into a fine spray 120 that forms a thin liquid layer 122 over the top surface of substrate 108. In embodiments of the present invention, the static liquid layer 122 can be as thin as 10 micrometers. Nozzle tip 114 is located on a control arm (not shown) that sweeps across the substrate surface as the substrate 108 is spun. In a particular embodiment, the nozzle tip 114 is shaped such that a fan-shaped spray pattern covers less than the radius of the substrate and as the substrate is rotated, the fan spray is moved approximately radially to completely cover the substrate surface with cleaning solution in a spiral-like pattern. In other embodiments, nozzle tip. 144 produces a cone spray pattern or an elliptical pattern.

Additionally, if desired, apparatus 100 can include a second spray nozzle, separate from the two-phase nozzle, for dispensing de-ionized water 155 from remote source 125, through conduit 127 to either spray nozzle tip 160 or stream nozzle tip 165. In a particular embodiment, spray nozzle tip 160 provides a full cone spray to uniformly apply a thin layer of de-ionized water on substrate 108 during a first, or “transition,” rinse. In another embodiment, spray nozzle tip 160 produces a fan-shaped spray pattern. Stream nozzle tip 165 provides a straight stream of de-ionized water to provide a higher flow rate of rinse water than spray nozzle tip 160. It should be appreciated that the two-phase nozzle may, but need not be, on a separate control arm than are spray nozzle tip 160 and stream nozzle tip 165.

Additionally, the distance which substrate 108 is held from plate 102 by substrate support 109 can be increased (by moving either support 109 or plate 102) to free the backside of the substrate 108 from liquid filled gap 118 to enable the substrate to be rotated at very high speed, such as during drying operations.

FIG. 2 is an illustration of an embodiment of a two-phase nozzle design of the present invention. A gas source 230 is coupled to conduit 226 at mixer 228. Mixer 228 is comprised of an array of small perforations 254 in conduit 226, forming injector ports through which the gas is injected into the liquid cleaning solution stream 252 as the fluid passes through conduit 226. An inert gas, such as N2, He, or Ar, is injected into the liquid stream 252 under sufficient pressure to atomize the cleaning fluid solution and produce a fine spray from the nozzle tip 214. The flow rate of liquid stream 252 can be varied in conjunction with the inlet pressure of gas at perforations 254 to optimize the atomization for the viscosity of the particular fluid used. In one embodiment, a liquid cleaning solution having a viscosity of approximately 35 cSt at a temperature of 25 C, such as ST-250 previously discussed, is atomized by injecting N2 at a pressure of 40-60 psi. As previously mentioned, the shape of nozzle tip 214 is designed to produce a spray pattern 213 capable of dispensing the atomized viscous cleaning solution in a uniform manner. Nozzle tip 214, for example, can be shaped to produce a fan-shaped spray pattern having a substantially rectangular cross-section, a cone spray pattern having a substantially circular cross-section or a cone spray pattern having a substantially elliptical cross-section, as shown in FIG. 2.

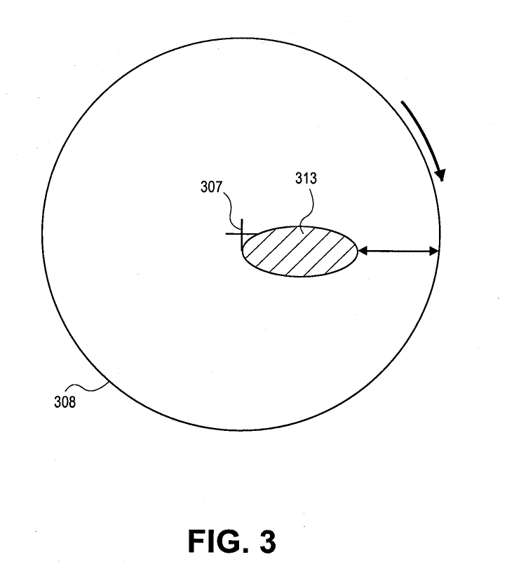

Two-phase nozzle 200 is attached to a control arm of a single substrate cleaning apparatus, of the type shown in FIG. 1. The control arm moves as the two-phase nozzle dispenses the cleaning solution to achieve a uniform liquid layer on the substrate surface. As shown in FIG. 3, the control arm imparts translational motion to the two-phase nozzle along as the substrate 308 rotates about its central axis 307. Thus, in the particular embodiment shown in FIG. 3, the spray pattern 313 moves radially across substrate 308 as substrate 308 rotates, producing a spiral spray path upon the substrate surface. Because the angular distance near the center of the substrate is less than the angular distance near the edge of the substrate, the dispense duration required to cover the center of the substrate is less than that required to cover the edge of the substrate. Therefore, confining the spray pattern 313 to less than the radius of the substrate as shown avoids over dispensing cleaning solution on the center of the substrate or under dispensing near the edge of the substrate. The translational motion in the radial direction occurs at predetermined speed dependent on the substrate 308 rotational speed to ensure substantially uniform coverage of cleaning solution. This is critical in particular embodiments where substrate 308 is rotated at a speed whereby the centrifugal force is sufficiently low that substantially all of the cleaning solution dispensed by the two-phase nozzle remains on the substrate surface. At such a low rotational speed, the uniformity of the cleaning solution across the wafer is dependent solely on a uniform spray dispense because centrifugal force does not redistribute the cleaning solution across the wafer surface.

Once the substrate is covered with a layer of liquid, the two-phase nozzle is shut off, discontinuing the cleaning solution dispense. In this way, a static liquid layer, or “puddle,” of cleaning solution is formed on the substrate surface. Dispense methods having both translational and rotational motion are advantageous for two reasons. First, very little cleaning solution volume is wasted because the rotation speed of the substrate is kept low enough that no significant amount of cleaning solution is shed from the substrate surface. Second a substantially uniform liquid layer over the substrate is formed relatively quickly without reliance on centrifugal force so that the residence time of the static liquid layer over the substrate is substantially equal across the entire substrate surface. The residence time is the duration the cleaning solution is present over the surface of the substrate. Therefore, even after the dispense is terminated, the static liquid layer continues to clean substrate 308.

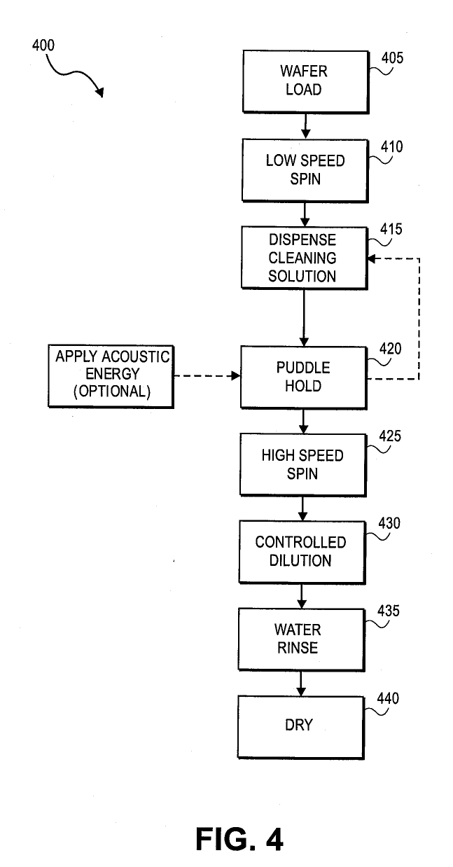

Set forth below are embodiments where the use of the single substrate cleaning process is particularly useful. Each embodiment makes reference to FIG. 4, which depicts process 400 incorporating the particular methods of the present invention. Each embodiment begins with step 405, loading the substrate into a single-substrate cleaning apparatus of the type previously described in reference to FIG. 1. The substrates applicable to the present invention include, for example, photo masking plates, compact discs, displays, and semiconductor wafers comprised of materials such as silicon, compound semiconductors, quartz, or sapphire. Semiconductor wafer substrate typically further include various materials formed thereon, including, but not limited to, metallic interconnects of copper (Cu) and low-k interlayer dielectrics.

After the substrate is loaded, it is rotated about its central axis during the low speed spin, 410. As previously described, the rotational speed is predetermined to be sufficiently low that centrifugal force is not great enough to shed a significant amount of the cleaning solution from the substrate edge once it is applied to the substrate surface. Thus, the maximum spin speed of operation 410 may depend on the viscosity of the particular cleaning solution for a given application. In a particular embodiment, for a fluid having a viscosity of approximately 35 cSt at a temperature 25 C, the speed of rotation during the fluid dispense is between approximately 30 rpm and 100 rpm.

At operation 415, the cleaning solution is dispensed to form a liquid layer over the surface of the substrate having a substantially uniform residence time. Embodiments of the present invention employ a two-phase nozzle to spray a small volume of cleaning solution onto the substrate. The two-phase nozzle atomizes the cleaning fluid and sprays a “low volume dispense,” or LVD, of approximately 10 ml to approximately 30 ml of cleaning solution. Use of a two-phase nozzle to atomize the cleaning fluid allows uniform application of even high viscosity cleaning solutions. A fan shape spray pattern covers less than the radius of the substrate and, as the substrate is rotated, the nozzle tip is moved approximately radially to completely cover the substrate with the cleaning solution in a spiral-like pattern. The substrate is rotated at a slow enough speed that substantially all of the dispensed cleaning solution remains on the substrate surface. Because centrifugal force is not relied upon to distribute the cleaning solution, very little cleaning solution is shed off the substrate surface and there is predominantly no bulk flux of cleaning solution from the substrate surface. This allows the two-phase dispense to be turned off after a puddle of cleaning solution is formed over the substrate. The small dispense volume required to produce a static liquid layer over the substrate reduces the chemical cost for cleaning a single substrate. The two-phase nozzle spray dispenses the low volume to form a substantially uniform liquid layer over the surface of the substrate in a period of time significantly less than the time required for the cleaning solution to remove residues from the substrate, thereby providing for a substantially equal residence time over the entire surface of the substrate. In a particular embodiment, a substantially uniform liquid layer is dispensed by the two-phase nozzle in between approximately 10 seconds and 20 seconds. A substantially equal residence time allows minimization and tight control over the time that the substrate surface is exposed to the cleaning solution.

During dispense 415, either fresh cleaning solution is applied to the substrate in a “single pass” mode or recycled/recirculated cleaning solution is applied to the substrate in a “multi-pass” mode. For single-pass embodiments, the problem of solvent contamination is virtually eliminated, which is advantageous where the substrate includes copper (Cu) interconnects. As previously discussed, the presence of metallic contamination can lead to copper (Cu) interconnect undercut if the metallic ions present in the solvent cleaning solution are capable of oxidizing metallic copper (Cu) to produce soluble cupric ions. In a particular embodiment, the viscous cleaning solution dispensed at operation 415 is a solvent having a pH greater than about 7, such as the ST-250 series previously discussed. For both single-pass and multi-pass modes, the present invention further reduces interconnect undercut by closely controlling the residence time of the cleaning solution over the substrate surface.

After the cleaning solution is dispensed onto the substrate and the two-phase nozzle is turned off, the puddle of cleaning solution is allowed to sit on the substrate for a predetermined duration at “puddle hold” 420. In a particular embodiment the cleaning solution is allowed to sit on the substrate surface for approximately 30 seconds. In other embodiments, the cleaning solution is allowed to sit for between approximately 30 seconds and 120 seconds. During the puddle hold 420 the substrate may, but need not, continue to rotate about its central axis. Thus, during most of the duration of the puddle hold 420, there is predominantly no bulk flux of cleaning solution to or from the substrate.

In certain embodiments of the present invention, acoustic energy in the megasonic frequency range is employed as discussed above during puddle hold 420 while the viscous cleaning solution is on the substrate. Application of megasonics improves the cleaning efficiency of the static liquid cleaning solution layer. The megasonic energy applied puddle hold 420 is typically in the frequency range of 700 kHz to 1.5 MHz, but may be higher. Megasonic energy is thought to cause acoustic streaming and reduce the fluid boundary layers adjacent to the device features of the substrate. Reduction in the fluid boundary layers improves transport of reactive species and reaction products. Acoustic energy is also thought to impart liquid molecular acceleration forces capable of overcoming van der Waals forces adhering particles to the substrate surface. The acoustic pressure waves push and pull particles with each frequency cycle to mechanically remove them from the substrate. Cavitation damage of the fragile device features on the substrate is avoided by limiting the acoustic power below the cavitation threshold (the power at which cavitation begins). The cavitation threshold is a function of both intermolecular and surface forces characteristic of a particular cleaning solution. High viscosity and low surface tension act to increase the cavitation threshold. In certain embodiments of the present invention, the cleaning solution has a lower surface tension than typical aqueous cleaning solutions, enabling application of relatively higher acoustic powers. In a particular embodiment utilizing a cleaning solution having a viscosity of approximately 35 cSt, the acoustic power range is between 0.01 W/cm² and 0.1 W/cm². For embodiments employing acoustic energy during puddle hold 420, the total duration of method 400 can be reduced and throughput increased. Furthermore, for embodiments where the substrate includes Cu interconnects, interconnect undercut can be reduced because the total time interconnects are exposed to the cleaning solution is shortened.

As shown in FIG. 4, in certain embodiments of the present invention, the cleaning solution is replenished after puddle hold 420 by repeating dispense 415 to dispense additional cleaning solution upon the substrate. It is advantageous to replenish cleaning solution if the reactive period of the particular cleaning solution is shorter than the total time required for removing the residues present on the substrate surface. Following the replenishment of the cleaning solution, puddle hold 420 may be repeated.

Following the puddle hold 420, the substrate is spun at a relatively high speed to remove a substantial portion of the static liquid layer of cleaning solution from the substrate surface during high speed spin 425. At this operation, it is advantageous for the speed of rotation to be sufficiently high to remove the bulk of the cleaning solution by centrifugal force to minimize the total time of method 400. A spin speed of 1000 rpm is typically sufficient for a fluid having a viscosity of approximately 35 cSt. After the high speed spin, the static liquid layer will typically only remain within features having aggressive aspect ratios, concave formations, etc. Thus, the static liquid layer may no longer form a substantially continuous puddle over the entire substrate surface, and instead form many discontinuous puddles.

Next, at operation 430, the cleaning solution remaining on the substrate surface is diluted in a controlled fashion. During controlled dilution 430, the substrate spin may be reduced to allow the formation of a static layer of dilutant. In one embodiment, a second chemical solution, such as acetone or another common solvent, is used to dilute the cleaning solution. Depending on the viscosity of the second chemical solution, it may be advantageous to apply the second chemical solution with a two-phase nozzle. In another particular embodiment, controlled dilution 430 is a “transition rinse,” whereby de-ionized water is dispensed through a spray nozzle to gradually dilute the cleaning solution. A transition rinse is particularly useful for certain solvent cleaning solutions, such as ATMI ST-250, which can form precipitates if the pH of the liquid is too rapidly changed. Precipitates, once formed, can contaminate the substrate surface and reduce device yield.

In a transition rinse embodiment particularly useful for avoiding precipitates, de-ionized water is dispensed from a spray nozzle tip 160, as shown in FIG. 1. The spray nozzle tip forms an atomized water spray which gently covers the substrate with a thin layer of water. This thin layer of water is then allowed to diffuse through the layer of cleaning solution from the top surface down to the substrate. The transition rinse is ideally continued until the pH or other chemical potential of the cleaning solution is approximately that of common de-ionized water. It is possible to tightly control the rate of pH change of the liquid present on the substrate surface by controlling the de-ionized water spray flow rate and the substrate rotation speed. For the most sensitive dilutions, the spray flowrate and substrate rotation speed can be very low so that a static layer of de-ionized water forms over the substrate surface. In this way the quantity of water applied over the substrate is small and does not radically modify the pH or other chemical potential of the cleaning solution remaining in contact with the substrate surface. Alternatively, if a static water layer is not required; the substrate speed and/or water spray flow rate can be incremented thereby increasing the rate of change in pH or other chemical potential. The transition rinse can be performed for a predetermined time depending on the particular cleaning solution's response to changes in attributes such as pH. For example, the solvent ST-250, with a pH of approximately 8, is known to form precipitates if the pH is too quickly reduced. A transition rinse consisting of a water spray of between approximately 100 ml/min and approximately 500 ml/min to gradually reduce the pH down to approximately that of de-ionized water over approximately 10 seconds significantly reduces the likelihood of precipitate formation. Thus, the controlled dilution of the present invention provides sufficient degrees of freedom to avoid a myriad of sensitivities cleaning solutions may have to the rinse operation.

After the controlled dilution operation 430, a water rinse 435 is performed. Rinse 435 is comprised of a stream of de-ionized water dispensed from, for example, the stream nozzle tip 165 of FIG. 1. The flowrate of de-ionized water may be significantly higher than that used during the transition rinse because there is no longer a sensitivity to water dilution. The higher the flowrate of de-ionized water, the more quickly the substrate is rinsed, so high flows are advantageous from a throughput standpoint. In a particular embodiment, the flowrate is approximately 1 liter/min. Furthermore, during rinse 435, substrate spin speed can be increased to further reduce the required rinse time, shortening the substrate cleaning process 400.

Finally, after the substrate has been adequately rinsed with de-ionized water, the substrate surface is dried at operation 440 with an IPA vapor or N2 dry, as is commonly done in the art.

Although the present invention has been described in language specific to structural features and/or methodological acts, it is to be understood that the invention defined in the appended claims is not necessarily limited to the specific features or acts described. Rather, the specific features and acts are disclosed as particularly graceful implementations of the claimed invention in an effort to illustrate rather than limit the present invention.

What is claimed is:

1. A method comprising:
placing a substrate to be cleaned in a single-substrate cleaning apparatus;
mixing a gas with a liquid cleaning solution in a two-phase spray nozzle to atomize the liquid cleaning solution; and
dispensing said atomized liquid cleaning solution from said two-phase spray nozzle to form a static liquid layer over a surface of said substrate.

2. The method of claim 1, further comprising holding the static liquid layer on the substrate for a substantially longer duration than the duration of said atomized liquid cleaning solution dispense.

3. The method of claim 2, wherein the static liquid layer is held on the substrate for between approximately 30 seconds and approximately 120 seconds.

4. The method of claim 1, wherein said static liquid layer has a substantially equal residence time over said substrate surface.

5. The method of claim 1, wherein said liquid has a viscosity substantially higher than that of water.

6. The method of claim 5, wherein said liquid has viscosity between approximately 20 cSt and 60 cSt.

7. The method of claim 6, wherein said liquid is a chemical solvent having a pH greater than about 7.

8. The method of claim 1, wherein said gas is an inert gas selected from the group consisting of N2, He, and Ar.

9. The method of claim 1, wherein said substrate surface includes Cu features.

10. The method of claim 1, wherein said atomized liquid is dispensed with a fan-shaped spray pattern.

11. The method of claim 1, further comprising spinning said substrate to remove a substantial portion of said static liquid layer.

12. The method of claim 1, further comprising dispensing onto said substrate a second liquid to slowly dilute said static liquid layer.

13. The method of claim 12, wherein said second liquid is de-ionized water dispensed through a spray nozzle to gradually dilute said static liquid layer with a first rinse.

14. The method of claim 13, wherein said first rinse duration is dependent on pH of said static liquid layer.

15. The method of claim 13, further comprising dispensing onto said substrate de-ionized water through a straight stream nozzle at flow rate higher than that of said first rinse.

16. A method comprising:
placing a substrate to be cleaned in a single-substrate cleaning apparatus;
mixing a gas with a liquid cleaning solution in a two-phase spray nozzle to atomize the liquid cleaning solution, wherein said liquid cleaning solution has a viscosity greater than approximately 30 cSt at room temperature;
dispensing said atomized solvent from said two-phase spray nozzle to form a liquid layer over a surface of said substrate; and
rinsing said liquid layer from said substrate surface.

17. The method of claim 16, wherein the total volume of said atomized liquid dispensed onto the substrate is less than approximately 30 ml.

18. The method of claim 16, further comprising:
applying acoustic waves to said substrate before rinsing said liquid layer from said substrate surface.

19. A method comprising:
placing a substrate to be cleaned in a single-substrate cleaning apparatus having a two-phase spray nozzle and a cone-spray nozzle;
mixing an inert gas with a liquid solvent in said two-phase nozzle to atomize said liquid solvent;
dispensing said atomized liquid solvent from said two-phase nozzle to form a liquid solvent layer over a surface of said substrate;
applying acoustic waves to said substrate after discontinuing said atomized liquid solvent dispense; and
dispensing a first rinse of de-ionized water from said spray nozzle to gradually dilute said liquid solvent layer on said substrate surface.

20. The method of claim 19, further comprising spinning said substrate to remove a portion of said liquid solvent layer before dispensing said first rinse.

21. The method of claim 19, wherein said first rinse has a duration dependent on pH of said viscous liquid layer on said substrate.

22. The method of claim 19, further comprising dispensing a second rinse of de-ionized water at a higher flow rate than the flow rate of de-ionized water in said first rinse.

23. The method of clam 22, wherein said second rinse is dispensed from a straight stream nozzle.

24. A machine-readable medium having stored thereon a set of machine-executable instructions that, when executed by a data-processing system, cause the system to perform a method to clean a substrate in a single-substrate cleaning apparatus comprising:
placing a substrate to be cleaned in the single-substrate cleaning apparatus;
mixing a gas with a liquid cleaning solution in a two-phase spray nozzle to atomize the liquid cleaning solution;
dispensing said atomized liquid cleaning solution from said two-phase spray nozzle to form a liquid layer over a surface of said substrate; and
rinsing said liquid layer from said substrate surface

25. The machine-readable medium of claim 24, further comprising holding the static liquid layer on the substrate for a substantially longer duration than the duration of said atomized liquid cleaning solution dispense.

26. The machine-readable medium of claim 24, wherein rinsing said liquid layer further comprises dispensing de-ionized water through a spray nozzle to gradually dilute said static liquid layer with a first rinse.
